(19) United States
(12) Patent Application Publication
(10) Pub. No.: US 2011/0226234 A1
(43) Pub. Date: Sep. 22, 2011

(54) CORROSION-RESISTANT MIRROR

(75) Inventors: Anne Dros, Paris (FR); Dominique Klein, Auzouer En Touraine (FR)

(73) Assignee: SAINT-GOBAIN GLASS FRANCE, Courbevoie (FR)

(21) Appl. No.: 13/119,728

(22) PCT Filed: Sep. 22, 2009
(86) PCT No.: PCT/FR2009/051778

§ 371 Date: Jun. 6, 2011

(30) Foreign Application Priority Data
Sep. 22, 2008 (FR) 0856355

(51) Int. Cl. F24J 2/10; G02B 5/08; G02B 5/10; B05D 5/06

(52) U.S. Cl. 126/684; 359/838; 359/853; 427/165; 126/714

(57) ABSTRACT

The invention relates to a mirror comprising a glass sheet and a silver layer applied to the glass and provided on its back with a protective coating comprising a layer of dried and crosslinked paint of the alkyd type and a layer of dried and crosslinked paint of the polyurethane type, the alkyd layer being located between the silver layer and the polyurethane layer. The invention also relates to its use for deflecting solar light onto a heat collector. The invention also relates to a process for manufacturing a mirror comprising:

a silver layer is deposited on a glass sheet using a silverplating solution; then

a layer of alkyd paint having a viscosity of between 25 and 110 seconds measured using a Ford No. 4 cup is applied on the side with the silver layer; then

the alkyd paint layer is dried and crosslinked; then

a layer of polyurethane paint having a viscosity of between 25 and 110 seconds measured using a Ford No. 4 cup is applied on the side with the alkyd layer; and then

the polyurethane paint layer is dried and crosslinked.

The invention relates to a mirror having a protective coating on the back so as to protect the reflecting metallic layer from corrosion. This mirror is particularly suitable for outdoor environments and may especially act as a solar mirror.

Mirrors generally comprise a glass substrate on which a reflecting layer, made of metal, generally silver, is deposited. The reflecting metal such as silver tends to be oxidized in the ambient air and it is necessary to protect it so as to increase its lifetime. A tin treatment is generally carried out just after silverplating, in order to improve the corrosion resistance of the silver. Protective layers are then applied, such as a layer of another metal, often based on copper, and/or one or more paint layers. A copper layer plated to the silver improves the corrosion resistance on the full face of the silver (“full face” means in the middle, such as at the bary center, and not on the edges). Thus, mirror manufacturing processes require several materials to be deposited in succession on the back of the mirror, thereby increasing the complexity and cost of the manufacture. To give an example, mirrors sold at the present time have the following structure:
glass/silver/copper/acrylate/epoxy/acrylate; or
glass/silver/copper/acrylate/acrylate/PU; or
glass/silver/epoxy (as indoor mirror).

It is endeavored to simplify the manufacture of mirrors by reducing the number of materials to be deposited without correspondingly sacrificing the effectiveness of the protection of the reflecting layer. This protection must be all the more effective when the mirror is intended for an aggressive environment, such as one in which it is exposed outdoors to all weathers, which is the case for solar mirrors. In particular if the mirror is cut after its various layers have been applied, it is necessary to give particular importance to corrosion resistance at the edges, since the edge of the mirror is then exposed and the edge of the silver layer is then liable to be more easily corroded.

The paints normally used to form protective layers contain large amounts of lead, generally between 1 and 12% lead, which, from the standpoint of lead toxicity, is no longer acceptable. It is therefore also desired to use paints with a lower lead content. Lead is also present in the paints intended for mirrors having a copper layer, as these limit edge corrosion of the copper.

The invention alleviates the abovementioned problems. It has now been found that a coating combining two types of particular paints affords very effective protection, to such a level that the usual copper layer is no longer essential, even for outdoor use. A paint contains at least one polymer resin and some solvent.

The invention relates in the first place to a mirror comprising a glass sheet and a silver layer applied to the glass and provided on its back with a protective coating comprising a layer of dried and crosslinked paint of the alkyd type and a layer of dried and crosslinked paint of the polyurethane type, the alkyd layer being located between the silver layer and the polyurethane layer.

The coating according to the invention comprises a layer of paint of the alkyd type and a layer of paint of the polyurethane (PU) type. The alkyd layer is applied to the mirror before the PU layer. The alkyd layer may be applied directly to the reflecting metal (generally silver) layer. The PU layer may be applied directly to the alkyd layer. The alkyd layer may have a thickness ranging from 10 nm to 60 nm and preferably from 25 nm to 40 nm. The PU layer may have a thickness ranging from 10 nm to 60 nm and preferably from 25 nm to 40 nm. Thus, the coating according to the invention may consist of the combination of an alkyd layer and a PU layer (without any other paint layer) applied directly to the reflecting layer starting via the alkyd layer.

The layers of paint may be applied by spray or curtain coating techniques. According to the curtain coating technique, a continuous stream of liquid paint is made to run over the entire width of the back of a running mirror. The paints are applied while being themselves at room temperature (generally between 15 and 40° C.), it being possible for the substrate to be coated to have been preheated, especially between 40 and 60° C. The fluidity of these paints makes it possible, in particular using the curtain coating technique, to cover at least the edge of the silver layer and even virtually the entire edge of the mirror (silver plus glass). During application, their viscosity is generally between 25 and 110 seconds, preferably between 30 and 100 seconds, as measured using a Ford No. 4 cup (ASTM D 1200). It should be noted that this is the desired viscosity irrespective of the temperature of application. It is therefore unnecessary to link the viscosity value with a temperature.

During application of the paint, a horizontal bed of rollers may be used to move the mirror. In this case, and if the glass sheet is curved, with a cylindro-parabolic shape, it rests on the rollers by its two linear edges. These linear edges lie along a direction perpendicular to the axis of the conveying rollers.

If the paints of the coating according to the invention are applied to the mirror in its final form (already cut and/or curved), the paints are advantageously applied to the edges of the mirror, at least to the edges of the silver layer. The curtain coating technique generally makes it possible to obtain such covering of the edges over the entire perimeter of the mirror.

The run speed of the mirror through the paint curtain may be varied so as to improve the covering of the edge, knowing that slowing the movement down improves this covering.

If it is desired for the edges of the silver layer over the entire perimeter of the mirror to be properly covered, it is preferred to pass the mirrors twice through the paint treatments (alkyd paint then PU paint) by turning the mirrors upside down between the two passes so that it is not the same edge of the mirror which strikes the paint curtains.

Thus, the invention also relates to a mirror having a silver layer which is coated over the entire perimeter of its edge via the protective coating according to the invention.

The liquid paint as used (before drying) contains from 0.1 to 50% and preferably from 5 to 40% and even from 10 to 35% by weight of a polymer resin (of the alkyd or polyurethane type, depending on the case).

At application, the paints contain a solvent (which may be xylene) in order to thin them, this solvent then being removed by drying. The alkyd-type paint contains at least 20% by weight and even 30% by weight of solvent (this being measured by determining the solids content by heating at 140° C. for example). The PU-type paint contains at least 20% by weight and even 30% by weight and even at least 35% by weight of solvent (which is measured by determining the solids content by heating at 140° C.). These layers are generally dried and crosslinked at a temperature between 120 and 250° C. and preferably between 150 and 210° C. and in such a way that they no longer have any tack. Each layer may be dried and crosslinked in less than 10 minutes without residual tack.

The PU paint contains an additive of the UV-resistance type, which may especially be titanium oxide or ZnO or benzophenone or benzotriazole or triazine advantageously combined with an antioxidant, for example of the HALS type. In general, the dried and crosslinked PU paint contains 0.1 to 0.5% antioxidant by weight.

The steps for manufacturing the mirror before the coating according to the invention is applied will not be described here in detail, as these involve techniques known to those skilled in the art. Before the coating according to the invention is applied, the mirror may be manufactured without copper, especially by the following succession of steps:
brightening of the glass surface;
sensitization of a first face of a glass sheet, for example using a stannous chloride solution; then
optionally activation on the same face by a palladium chloride (PdCl₂) solution; then
deposition on the same face of a reflecting metal layer, such as a silver layer, especially using a silverplating solution; then
passivation by a stannous chloride solution; and then
application, by spraying, of a thin undercoat (one or more molecular layers) of a keying primer generally of the silane type, especially an amino silane.

The mirror may also be manufactured with a copper layer, especially according to the following process:
brightening of the glass surface;
sensitization of a first face of a glass sheet, for example using a stannous chloride solution; then
optionally activation on the same face by a palladium chloride (PdCl₂) solution; then
deposition on the same face of a reflecting metal layer, such as silver, especially using a silverplating solution; and then
deposition of a copper layer using an aqueous copper sulfate solution.

In the latter case in which a copper layer may be provided, it is unnecessary to apply an undercoat of a keying primer (such as a silane).

The coating according to the invention is then applied to this structure.

The protective coating according to the invention therefore comprises, as essential elements, a layer of dried and crosslinked paint of the alkyd type and a layer of dried and crosslinked paint of the polyurethane type, the alkyd layer being located between the silver layer and the polyurethane layer. It is not excluded to apply at least one other layer (called “additional layer”) to the mirror between the silver layer and the protective coating according to the invention, but this is not necessary.

In particular, this additional layer may be a layer of dried and crosslinked paint of the acrylic type. Thus, between the silver layer and the alkyd layer, there may be nothing, or only a keying primer layer (such as a silane), the thickness of which is generally less than 10 nm and even less than 5 nm, which generally acts as a monomolecular layer. The alkyd paint layer after crosslinking may therefore be the first layer containing a crosslinked polymer applied after the silver layer. In this case, the layer of alkyd paint in a solvent is applied directly to the silver layer, where appropriate after passivation of the silver and application of a keying primer, especially a silane.

The polyurethane layer may be the external layer, i.e. the final layer on the back of the mirror.

The alkyd paint layer and the PU paint layer are dried and crosslinked, for example thermally (by heating between 120 and 250° C.), generally in the ambient air.

The various layers of the mirror are applied on the same side of a glass sheet, generally a mineral (silica-based) glass. In general, the glass sheet has been cut, generally into a quadrilateral, from a float glass ribbon or from another, larger glass sheet. If the final mirror has to be curved, the glass sheet is bent before the silverplating is applied.

The glass sheet, whether curved or not, has a thickness generally ranging from 2 to 6 mm. The glass is preferably extra-clear glass, i.e. it has an energy transmission of greater than 85% and even greater than 89% for a glass thickness of 3.2 mm (see in particular the Air Mass 1.5 ISO 9050 Standard). This does not mean that the glass necessarily has a thickness of 3.2 mm, rather it means that the energy transmission is measured with this thickness. The glass sold by Saint-Gobain Glass France under the brand name Diamant is particularly suitable. The silver layer may have a thickness ranging from 500 to 1600 mg/m². For applications as solar mirrors, this layer preferably has a thickness of greater than 850 mg/m², especially a thickness between 900 and 1600 mg/m² and generally between 950 and 1300 mg/m².

This is because it turns out that a silver layer with a conventional thickness such as 750-800 mg/m², although quite sufficient for domestic applications (for example as bathroom mirrors), does not reflect all the solar light spectrum, especially in the ultraviolet range. In other words, the UV radiation passes partially through the silver layers that are too thin, this not being a drawback in domestic applications since this nonreflected UV is not in the visible range. However, for an application as a solar mirror, the good reflection of this UV is desirable as it has a not inconsiderable amount of light energy which it is advantageous to collect. In addition, the UV reaching the organic protective layers tends to accelerate the aging of said layers and, from this standpoint too, it is beneficial for the reflecting layer to stop the UV as far as possible. To improve the energy reflection, especially in the 350-700 nm range, it has even been found that the silver layer can be thickened rather than applying a copper layer, thereby helping to simplify the process. This is because even though a copper layer tends to improve the UV reflection, for the same thickness, the silver reflects much better in the 350-700 nm range.

If the mirror according to the invention is intended to act as a solar mirror, it may be curved or plane. If it is plane, the mirror is generally a component forming part of an assembly of mirror components arranged so as to constitute a Fresnel mirror or a mirror of the heliostat type. This assembly makes the solar light converge on a heat collector. In general, this collector consists of a tube through which a heat-transfer fluid (water, molten salts, synthetic oils, or steam) flows. This fluid is heated by the solar energy and this energy is recovered in the form of electricity by any suitable process such as, for example, what is called the “Rankine cycle”. The problems due to energy fluctuation inherent to solar energy (alternation between night and day, the passage of clouds, etc.) may be circumvented either by storing heat (with a hot fluid reservoir) or by hybridizing the solar concentrators with a conventional thermal power plant (the boiler and the solar heat feeding the same steam turbine). In fact, for applications as a Fresnel mirror or heliostat, the mirrors manufactured are plane or slightly curved at the time of positioning them, by applying mechanical stresses (cold bending). The glazing panel is thus given a shape closer to the ideal curvature.

In the case of a Fresnel mirror, the various mirror components are generally smaller than 3 m² since the smaller these plane mirrors, the easier it is to arrange them so as to make the light rays converge on the collector. These plane mirrors are generally cut after the various layers have been applied to their back so that the edge of the silver layer is not coated. In this case, good edge corrosion resistance is particularly desirable.

In the case of mirrors of the heliostat type, the various mirror components may have an area ranging from 1 m² to 25 m².

If the glass sheet supporting the various layers has undergone hot bending (irreversible cold bending: the mirror cannot resume the plane shape under the effect of its own weight or of a stress without breaking), the curved shape of the mirror itself makes the light converge on the collector. Specifically, the aim is to give the mirror a parabolic profile in at least one direction (a single direction or two mutually orthogonal directions), the light rays being reflected onto the focus of said parabola, a light energy collector being placed at this focus. If the mirror is bent hot so as to be curved in a single direction, a person skilled in the art usually refers to a cylindro-parabolic shape in which two of the edges of the mirror are linear. In this type of mirror, the collector is a linear pipe onto which the mirrors reflect the radiation, said collector being placed at the point of convergence of said radiation (the focus in the case of a parabola). In a plane perpendicular to the collector, the mirror is curved. In a plane parallel to the collector, the mirror is not curved.

The final curved mirror (as installed in solar mirror fields) may consist of a single plate or comprise several juxtaposed plates each forming a segment of a parabola. In particular in the case of a cylindro-parabolic mirror, the parabola in the plane perpendicular to the collector may consist of two or four juxtaposed plates. The plates have a shape that approximates the parabolic shape without necessarily corresponding completely thereto, the essential point being that the maximum amount of light radiation reaches the collector at the focus. To better approximate a parabola, it is not excluded for the various juxtaposed plates to have different shapes. It is also possible to choose to make them identical by placing them in such a way that their shape approaches as far as possible a parabola. Moreover, upon positioning them, they may be stressed so as to impose a shape on them at the ambient temperature. These curved mirrors may be made to size by cutting the glass before bending, the bending being carried out thereafter, and the various layers (silverplating and then protective layers) then being applied to its back, on the convex side. In this case, the edge of the mirror is also covered with the various protective layers in such a way that the edge corrosion resistance is less crucial than in the case of cutting after the protective layers have been applied. A curved mirror (bent hot), especially for application as a solar mirror, may have an area ranging from 0.1 to 10 m².

The invention also relates to a process for manufacturing a mirror comprising:
a silver layer is deposited on a glass sheet using a silverplating solution; then
a layer of alkyd paint having a viscosity of between 25 and 110 seconds measured using a Ford No. 4 cup is applied on the side with the silver layer; then
the alkyd paint layer is dried and crosslinked; then
a layer of polyurethane paint having a viscosity of between 25 and 110 seconds measured using a Ford No. 4 cup is applied on the side with the alkyd layer; and then
the polyurethane paint layer is dried and crosslinked.

Before the silver layer is deposited, the glass sheet may undergo hot bending, the silver layer and the paint layers being applied to the convex side of the glass sheet.

The invention also relates to the device comprising a heat collector and a solar mirror comprising the mirror according to the invention. The mirror according to the invention is advantageously used outdoors for deflecting solar light onto a heat collector. This use is particularly advantageous in sunny regions, especially in the Earth's range of latitude lying between 45° North and 45° South.

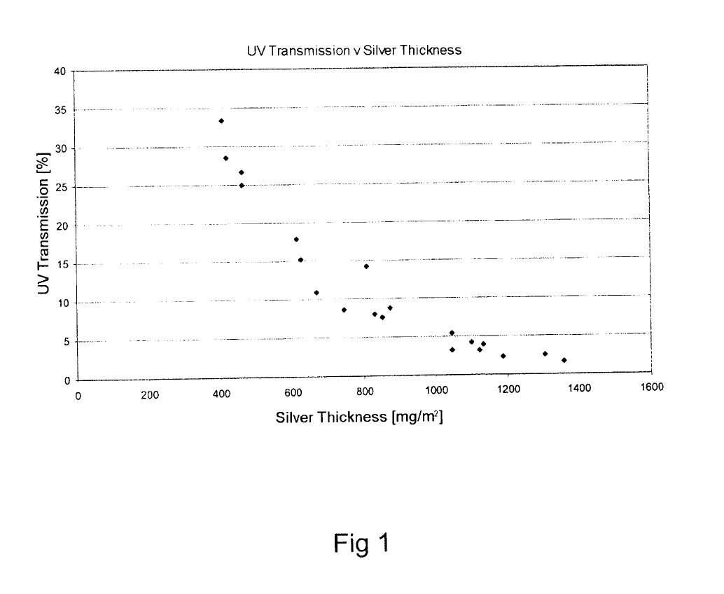

FIG. 1 illustrates the influence of the thickness of a silver layer on the UV transmission. This shows that above 800 mg/m² of silver, the UV transmission drops below 10% and that the more this thickness increases, the less the UV passes through the silver layer. This low UV transmission is good for the integrity of the paint layer applied directly to the silver, since it is known that UV degrades polymers and therefore paints.

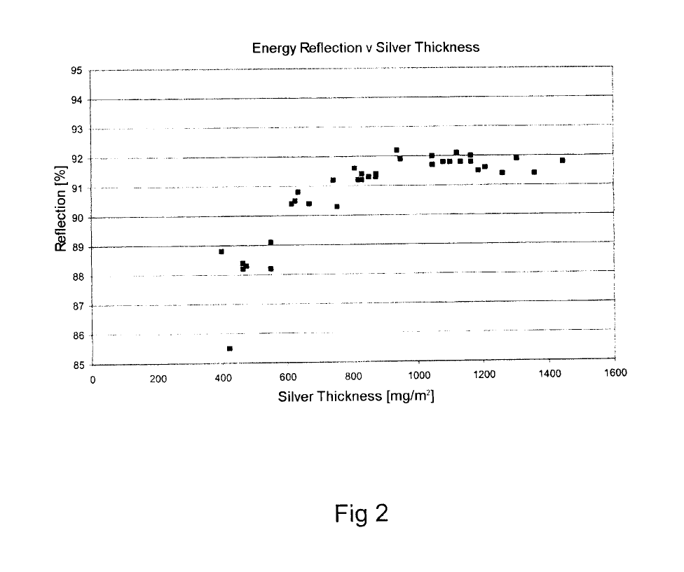

FIG. 2 illustrates the influence of the thickness of a silver layer on the energy reflectivity of a mirror according to the invention. This figure shows that there is a substantial gain in reflection above 800 mg/m².

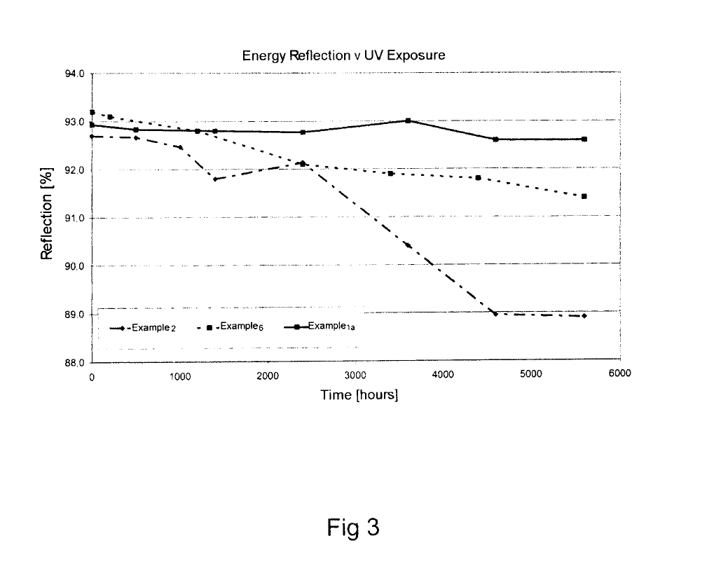

FIG. 3 illustrates the UV resistance with time for various mirrors produced within the context of the examples.

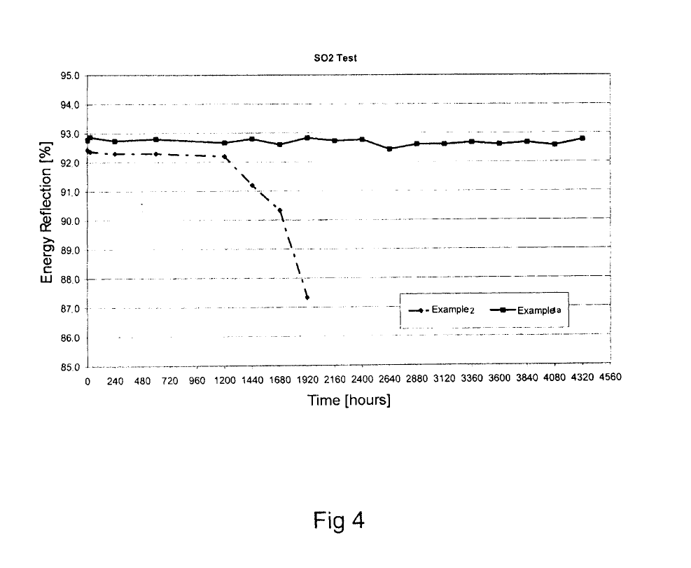

FIG. 4 illustrates the resistance to an SO₂-contaminated atmosphere (within the context of a test according to the EN 1096-2 standard) of various mirrors produced within the context of the examples (1a and 2).

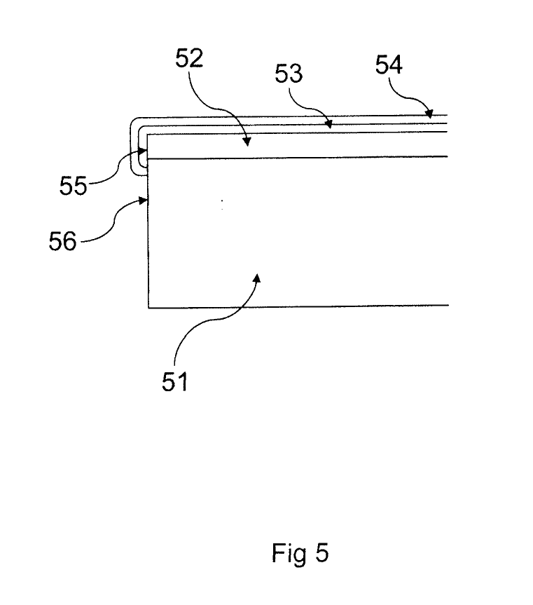

FIG. 5 illustrates the structure of the mirror according to the invention as seen in cross section and at one edge. The thicknesses of the layers have not been drawn to scale. The glass 51 is firstly coated with the silver layer 52, then with the layer 53 of an alkyd-type paint, which is dried and crosslinked, and then with the layer 54 of polyurethane-type paint, which is dried and crosslinked. This figure shows that these two paints have flowed over the edge and have covered the edge of the silver layer 55 and part of the edge of the glass sheet 56. This covering is substantially the same over the entire perimeter of the mirror.

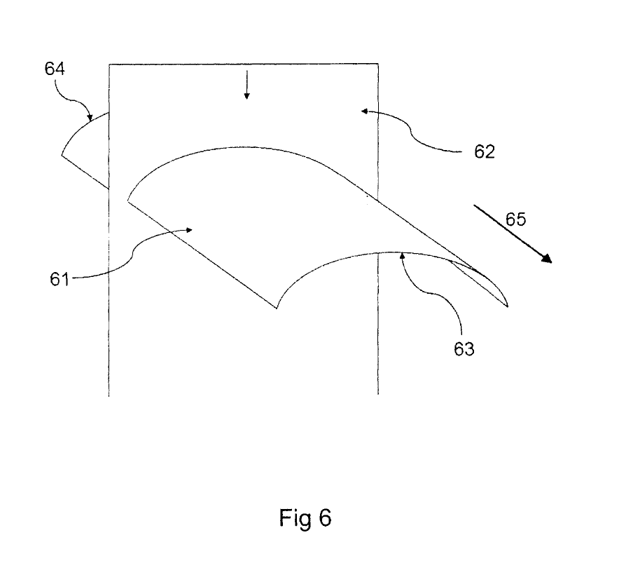

FIG. 6 illustrates the method of applying the paints to the back of an already curved mirror. A paint curtain 62 runs on the back (convex side) of the mirror 61. The mirror runs in the direction of the arrow 65 beneath the paint curtain, which is stationary. The edge 63 of the mirror strikes the curtain first. The edge 63 is generally coated more than the edge 64. The other two edges (not numbered) of the mirror are linear and parallel. The mirror rests via its linear edges on the conveying rollers, the axis of which is perpendicular to the run direction of the mirror. These edges are generally correctly covered by the paints, at least as regards the silver layer.

In the following examples, the mirrors were tested by the following techniques:
reflection: the mirror was subjected to the CASS test according to the ISO 9227 Standard and then the light reflection was measured according to the ISO 9050 (with Air Mass=1.5) Standard;
corrosion: the mirror was subjected to the CASS test according to the ISO 9227 Standard and the distance from the edge that the silver had been corroded was measured. The measurements were made according to whether the edges were covered by the various layers (including Ag and Cu) and according to whether the edges were not covered by the various layers;
salt fog test: ISO 9227 Standard; and
reflection after application of UV: the mirror was subjected to 4000 hours of UV with an intensity of 0.55 W/m² at 340 nm on the side with the glass according to the SAE J1885 Standard (with complete illumination) and then the light reflection was measured according to the ISO 9050 (Air Mass=1.5) Standard.

The following abbreviations are also used:
Ag: silver
Cu: copper
ALK: alkyd
PU: polyurethane
ACY: acrylic
ACA: acrylate
EPY: epoxy.

### EXAMPLE 1

An extra-clear glass of the Diamant brand (90.4% energy transmission) sold by Saint-Gobain, cut to the dimensions 1700×1640 mm, was bent so as to have a parabolic profile. When it was placed on a horizontal plane, the distance between the plane and the highest point was about 60 mm.

A silver layer was deposited on the convex side by one of the processes already mentioned earlier without a copper layer. The keying primer was the silane A1100 from the company Silquest.

After the liquid was removed from the surface by blowing, so as to obtain a dry surface, followed by pre-heating in an oven at 50° C., an alkyd paint layer was applied. This paint was prepared from a paint of 21775 reference sold by the company Fenzi, to which xylene was added so as to obtain a viscosity of 50 seconds at 20° C. using a Ford No. 4 cup. This formulation was applied to the convex side of the glass sheet at room temperature (the mirror therefore being preheated to 50° C. and the paint was run as a curtain at room temperature) using the curtain coating technique. The paint was dried in an oven at 90° C. for 1 minute 15 seconds. Next, a polyurethane paint layer was applied, again on the convex side, to the dried alkyd layer. This polyurethane paint was prepared from a paint of the SK2410 brand sold by the company Valspar to which xylene was added so as to obtain a viscosity of 50 seconds at 20° C. using a Ford No. 4 cup. This formulation was applied at room temperature using the curtain coating technique. The paint was dried in an oven at 170° C. for three minutes.

Specimens of this mirror were cut in order to carry out the tests, the results of which are given in the table. The “Thickness” column gives the thicknesses of each of the layers in mg/m² for the Ag and Cu layers and in μm for the other layers. The “Initial energy reflection” column gives the reflection just after manufacture of the mirror and therefore before any test (CASS or UV exposure for 4000 h).

### EXAMPLES 2 to 6

These examples were as in the case of example 1 except that a different protective coating was applied (but using similar techniques), the nature and the thickness of which are specified in the table. In the case of example 6, a copper layer was applied using an aqueous copper sulfate solution. Examples 2, 4, 5 and 6 are comparative examples and do not illustrate the invention.

TABLE 1

| | | | | Energy | Energy | Corrosion |
|---|---|---|---|---|---|---|
| | | | Initial | reflection | reflection | after CASS |
| | | | energy | after | after CASS | (1 cycle) |
| | | | reflection | 4000 h of | (1 cycle) | of exposed |
| Ex. No. | Structure | Thicknesses of the layers | (%) | UV (%) | (%) | edges (μm) |
| 1a | Ag/ALK/PU | 850 mg · m⁻²/40 μm/40 μm | 92.6 | 92.5 | 92.5 | <250 |
| 1b | Ag/ALK/PU | 1000 mg · m⁻²/40 μm/40 μm | 93.0 | 93.0 | 93.0 | <250 |
| 2 (comp) | Ag/ACY/ALK | 850 mg · m⁻²/25 μm/25 μm | 92.6 | 89.5 | 92.5 | <250 |
| 3 | Ag/ACY/ALK/PU | 850 mg · m⁻²/25 μm/25 μm/35 μm | 92.6 | 91.5 | 92.5 | <250 |
| 4 (comp) | Ag/PU | 850 mg · m⁻²/40 μm | — | — | — | destruction |
| 5 (comp) | Ag/ALK | 850 mg · m⁻²/45 μm | — | — | — | destruction |
| 6 (comp) | Ag/Cu/ACA/EPY/ACA | 700 mg · m⁻²/300 mg · m⁻²/35 μm/45 μm/45 μm | 93 | 92 | 92.5 | destruction |

1. A mirror, comprising:
a glass sheet:, and
a silver layer,
wherein the silver layer is present on a back of the glass with a protective coating comprising
a layer of dried and crosslinked alkyd paint and
a layer of dried and crosslinked polyurethane paint, and
wherein the alkyd layer is present between the silver layer and the polyurethane layer.

2. The mirror as claimed in claim 1, wherein the silver layer has a thickness of greater than 850 mg/m².

3. The mirror as claimed in claim 1, wherein the silver layer has a thickness of between 900 and 1600 mg/m².

4. The mirror as claimed in claim 1, wherein an edge of the silver layer is coated over an entire perimeter of the mirror by the protective coating.

5. The mirror as claimed in claim 1, wherein the polyurethane layer is applied directly to the alkyd layer.

6. The mirror as claimed in claim 1, wherein the polyurethane layer is present in an outermost layer of a back of the mirror.

7. The mirror as claimed in claim 1, wherein
the alkyd paint layer comprises a crosslinked polymer, and
the alkyd paint layer is in contact with the silver layer.

8. The mirror as claimed in claim 1, wherein an energy transmission of the glass is greater than 85% for a glass thickness of 3.2 mm.

9. The mirror as claimed in claim 1, wherein the mirror is curved.

10. A device, comprising:
a heat collector; and
a solar mirror comprising the mirror of claim 1.

11. A Fresnel mirror or heliostat, comprising:
a mirror as claimed in claim 1.

12. A method, comprising:
irradiating the mirror as claimed in claim 1 with light and deflecting the light onto a heat collector.

13. The method as claimed in claim 12, wherein the mirror is placed within the Earth's range of latitude lying between 45° North and 45° South.

14. A process for manufacturing a mirror comprising:
depositing a silver layer on a glass sheet with a silverplating solution; then
applying a layer of alkyd paint having a viscosity of between 25 and 110 seconds measured with a Ford No. 4 cup on the silver layer; then
drying and crosslinking the alkyd paint layer; then
applying a layer of polyurethane paint having a viscosity of between 25 and 110 seconds measured with a Ford No. 4 cup is-applied on the side with the alkyd layer; and then
drying and crosslinking the polyurethane paint layer thereby obtaining the mirror.

15. The process as claimed in claim 14, further comprising, before depositing the silver layer, hot bending the glass sheet,
wherein the silver layer, the alkyd paint layer, and the polyurethane paint layer are applied on a convex side of the glass sheet.

16. The process as claimed in claim 14, wherein the alkyd paint layer and the polyurethane paint layer are applied by a curtain coating technique, and the mirror present beneath a curtain is conveyed by at least one conveying roller.

17. The mirror as claimed in claim 1, wherein an energy transmission of the glass is greater than 89% for a glass thickness of 3.2 mm.
